(19) United States
(12) Patent Application Publication
(10) Pub. No.: US 2015/0055217 A1
(43) Pub. Date: Feb. 26, 2015

(54) STEREOGRAM DISPLAY MEMBER AND FORMING METHOD THEREOF

(71) Applicant: Nango Co., Ltd., Kyoto (JP)

(72) Inventor: Nobuyasu Gomyou, Kyoto (JP)

(21) Appl. No.: 14/004,113

(22) PCT Filed: Jan. 21, 2013
(86) PCT No.: PCT/JP2013/051062

§ 371 Date: Sep. 9, 2013

(30) Foreign Application Priority Data
Feb. 9, 2012 (JP) 2012-026126

(51) Int. Cl. G02B 27/22

(52) U.S. Cl. CPC G02B 27/22
USPC 359/462; 29/592

(57) ABSTRACT

It is an object of the invention to provide a stereogram display member that replicates a stereogram with a concavo-convex pattern formed on a three-dimensional object. A stereogram display member 1 has a stereogram in which an image appears in three dimensions due to binocular disparity. The stereogram display member 1 includes a substrate 2 having a surface 2a formed with a concavo-convex pattern, and a stereogram is replicated by shadings generated by the concavo-convex pattern. The concavo-convex pattern is formed by converting a machining data created based on an original picture data representing a color-field stereogram into an NC data and then machining the surface of the substrate based on the NC data.

### TECHNICAL FIELD

The present invention relates to a stereogram display member with a stereogram replicated by a concavo-convex pattern formed on a three-dimensional object and a forming method thereof.

### BACKGROUND

There have been known stereograms in which images appear in three dimensions due to binocular disparity (see Patent Document 1, for example). Anyone can create such stereograms using free software or the like, for example. There have also been proposed such application products as posters, calendars, and fans printed with stereograms.

Patent Document 1: Japanese Patent Application Publication No. 2004-94739

### SUMMARY

### Problems to be Solved by the Invention

Such stereograms have often been viewed printed on such print medium as paper sheets. For example, framed postures printed with stereograms are hung on walls as interior decorations.

It is an object of the invention to provide a highly-enjoyable stereogram display member by replicating a stereogram with a concavo-convex pattern formed on a three-dimensional object instead of printing.

### Means to Overcome the Problem

A stereogram display member according to claim 1 of the present invention is a stereogram display member with a stereogram in which an image appears in three dimensions due to binocular disparity, comprising a substrate having a surface formed with a concavo-convex pattern. The stereogram is replicated by shading generated by the concavo-convex pattern, and the concavo-convex pattern is formed by converting a machining data created based on an original picture data representing a color-field stereogram into an NC data and then machining the surface of the substrate based on the NC data.

The stereogram display member according to claim 2 of the present invention is characterized by that the concavo-convex pattern is formed such that parts corresponding to lighter parts of the color-field stereogram protrude relative to surrounding parts and that parts corresponding to darker parts of the color-field stereogram are recessed relative to surrounding parts.

The stereogram display member according to claim 3 of the present invention is characterized by that the maximum depth of the concavo-convex pattern is 1 mm to 5 mm.

The stereogram display member according to claim 4 of the present invention is characterized by being a mold used in a forming process.

A stereogram display member forming method according to claim 5 of the present invention is a stereogram display member forming method for forming a stereogram display member with a stereogram in which an image appears in three dimensions due to binocular disparity, and herein the stereogram display member according to any of claims 1 to 3 is used as a mold in a forming process for forming another stereogram display member.

A stereogram display member forming method according to claim 6 of the present invention is a stereogram display member forming method for forming a stereogram display member with a stereogram in which an image appears in three dimensions due to binocular disparity, and including the steps of: creating an original picture data representing a color-field stereogram; creating a machining data based on the original picture data for forming a concavo-convex pattern such that parts corresponding to lighter parts of the color-field stereogram protrude relative to surrounding parts and that parts corresponding to darker parts of the color-field stereogram are recessed relative to surrounding parts; creating an NC data based on the machining data; and forming the concavo-convex pattern on a surface of a substrate by machining the surface of the substrate based on the NC data.

### Effects of the Invention

According to the stereogram display member of the present invention, because the concavo-convex pattern is formed based on the NC data generated based on the original picture data representing the color-field stereogram, a stereogram can be replicated by shading generated by the concavo-convex pattern. Also, because the stereogram is replicated by shading generated by the concavo-convex pattern, a highly-enjoyable stereogram display member can be provided.

Also, according to the stereogram display member of the present invention, because the concavo-convex pattern is formed such that parts corresponding to lighter parts of the color-field stereogram protrude relative to surrounding parts and that parts corresponding to darker parts of the color-field stereogram are recessed relative to surrounding parts, the same image as in the color-field stereogram can be viewed in three dimensions.

Also, according to the stereogram display member of the present invention, because the maximum depth of the concavo-convex pattern is 1 mm to 5 mm, the stereogram can be replicated by shading generated by the concavo-convex pattern, and also burden on a tool during machining can be reduced.

Also, because the stereogram display member of the present invention is a mold for press molding or injection molding, another stereogram display member can be easily formed with the mold.

Also, according to the stereogram display member forming method of the present invention, a stereogram display member is used as a mold when forming another stereogram display member through press molding or injection molding, stereogram display members can be easily mass produced without performing time-consuming machining processes.

Also, according to the stereogram display member forming method of the present invention, the concavo-convex pattern is formed by machining using the NC data generated based on the original picture data representing the color-field stereogram, shading generated by the concavo-convex pattern can replicate a stereogram.

### BRIEF DESCRIPTION OF THE DRAWINGS

FIG. 1 is a perspective view of a stereogram display member according to a first embodiment of the present invention.

FIG. 2 is a flowchart representing a stereogram display member forming method according to the first embodiment of the present invention.

FIG. 3(a) is a view showing an example of picture, and FIG. 3(b) is a view showing an example of shaded-picture data.

FIG. 4 is a view showing an example of color-field stereogram.

FIG. 5 is a cross-sectional view taken along a V-V line of FIG. 1.

FIG. 6 is a perspective view showing a stereogram display member according to a first example.

FIG. 7 is a view showing a shaded-picture data used in a second example.

### DETAILED DESCRIPTION

### First Embodiment

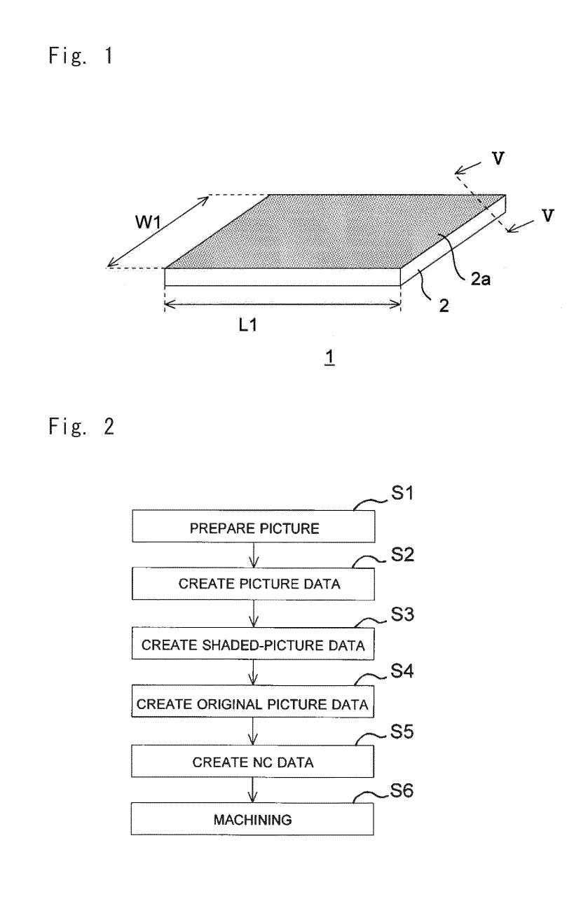

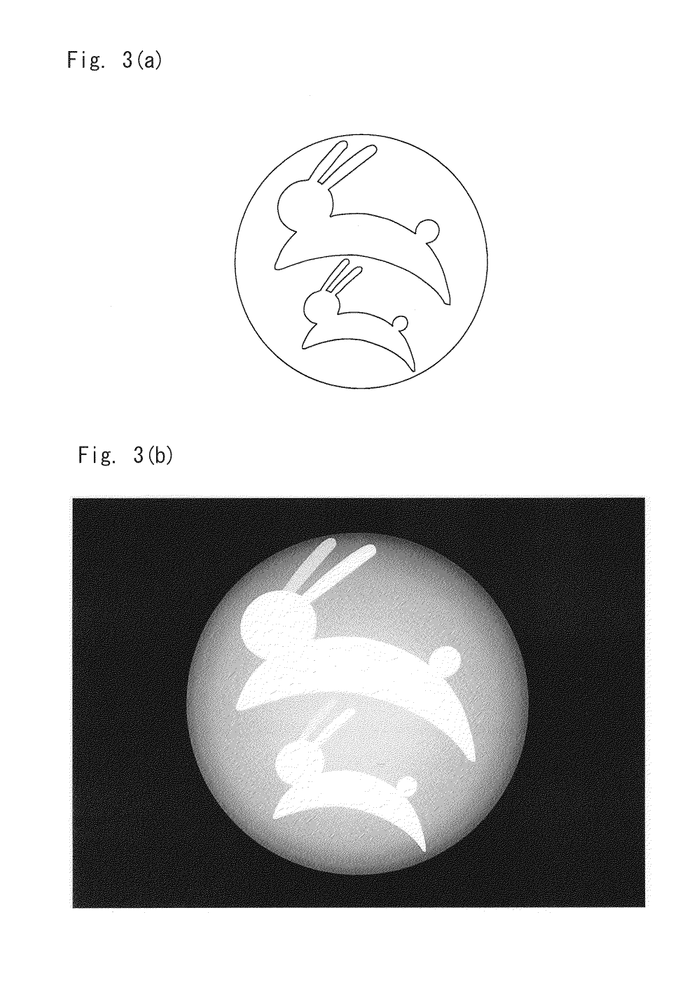

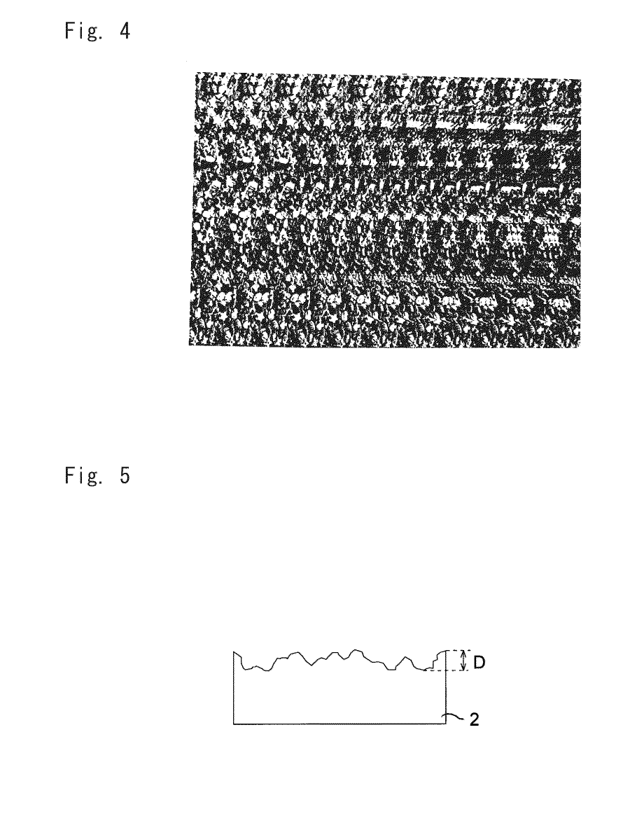

A stereogram display member and a forming method thereof according to a first embodiment of the present invention will be described while referring to the accompanying drawings. FIG. 1 is a perspective view of the stereogram display member according to the first embodiment of the present invention. FIG. 2 is a flowchart representing a forming method of the stereogram display member of FIG. 1. FIG. 3(a) is a view showing an example of picture, and FIG. 3(b) is a view showing an example of shaded-picture data. FIG. 4 is a view showing an example of color-field stereogram. FIG. 5 is a cross-sectional view taken along a V-V line of FIG. 1.

A stereogram display member 1 shown in FIG. 1 includes a substrate 2, and a surface 2a of the substrate 2 is formed with a concavo-convex pattern through machining. A stereogram is replicated with shading generated by the thus-formed concavo-convex pattern, and a graphic appears in three dimensions when a viewer shifts focus of both eyes. In this description, a graphic that appears in three dimensions will be referred to as “three-dimensional graphic”.

A forming method of the stereogram display member 1 will be described with reference to a flowchart shown in FIG. 2. First, a picture in black and white (hereinafter referred to as “picture”) is prepared as an origin of the three-dimensional graphic (S1). The picture may be hand drawn, photographs, copyright-free elements, letters, or the like. In this example, “moon and rabbits” shown in FIG. 3(a) is prepared as the picture. Next, a picture data is created from the picture (S2), and a shading process is performed on the picture data to create a shaded-picture data. In this shading process, shading is added such that parts to be viewed as nearer are lighter and that parts to be viewed as farther are darker. FIG. 3(b) shows an example of a shaded-picture data of “moon and rabbits.” In the example shown in FIG. 3(b), the shading process is performed such that the rabbits are lighter in whole and that the moon gradually becomes darker from the center toward the periphery. Performing such shading process enables a three-dimensional graphic of rabbits jumping before a spherical moon to be observed. Note that a process to emphasize the shading (a process to emphasize contrasts) may be further performed on the shaded-picture data. Performing the process to emphasize the shading enables the three-dimensional graphic to be observed more clearly.

Next, an original picture data (a color-field stereogram data) representing such color-field stereogram as that shown in FIG. 4 is created based on the shaded-picture data (S4). The original picture data (color-field stereogram) may be created using commercial software or free software, and a method for creating the same is well-known in the art, so detailed description thereof will be omitted. Next, a numeric control (NC) data is created based on the original picture data (S5). Creation of the NC data will be described later.

At the end, machining is performed on the substrate 2 based on the NC data using a machining center so as to form concavo-convex pattern on the surface 2a of the substrate 2 (S6). Shading generated by the concavo-convex pattern replicates the same pattern on the surface 2a of the substrate 2 as that obtained by printing the above-mentioned color-field stereogram in black and white on such a medium as a paper sheet, and the three-dimensional graphic appears when a viewer shifts focus of both eyes. That is, machining is performed such that parts corresponding to the lighter parts of the color-field stereogram protrude relative to surrounding parts and that parts corresponding to the darker parts of the color-field stereogram are recessed relative to surrounding parts. As a result, lightness of protrusions or convex parts is higher relative to surrounding parts, and lightness of recesses or concave parts is lower relative to surrounding parts, and such differences in lightness replicate a predetermined pattern. When this pattern is observed with focus of eyes shifted, then the three-dimensional graphic appears (i.e., the picture appears in three dimensions).

With regard to machining, it is preferable that machining be performed continuously from the start to the end without a stop (uninterrupted machining). If the machining stops in the middle, then a position gap occurs, affecting appearance of the three-dimensional graphic.

Here, the substrate 2 may be formed of any materials that can be machined, such as metal, resin, wood, and the like. Also, the stereogram display member 1 of this embodiment such as that shown in FIG. 1 may be applied to such interior decorations as decorative objects and wall hangings.

Next, creation of the NC data in S5 will be described. The NC data may be created using commercial software. In this embodiment, the ART Function of Mastercam (registered trademark) of CNC Software, Inc. is used.

In order to create the NC data using such commercial software, first a machining data is generated based on the picture data, and then the machining data is converted into the NC data. The machining data is data for forming a concavo-convex pattern on the substrate 2 such that parts corresponding to parts of the color-field stereogram represented by the picture data with higher lightness protrude relative to surrounding parts and that parts corresponding to those with lower lightness are recessed relative to surrounding parts, and the machining data is generated by designating a machining area size, a machining depth, a resolution of the machining data (dpi), and a shading vale. The machining area size is defined by a length and a width of an area as a machining object. With regard to the example shown in FIG. 1, it is defined by a length L1 and a width W1 of the surface 2a.

The machining depth indicates a maximum machining depth of machining. As shown in FIG. 5, the concavo-convex pattern is formed within a range of a designated machining depth D. If the machining depth D is too shallow, then shading may not be strong enough, making it difficult to observe the three-dimensional graphic. If the machining depth D is set deeper, then the descriptive power is increased, making it easier to observe the three-dimensional graphic. Increasing the machining depth D beyond a certain depth, however, does not further increase the observability of the three-dimensional graphic. Also, if an excessively deep depth is designated, then a tool may not bear the machining operation, and there is a danger that the tool breaks during the machining operation, disabling the uninterrupted machining. The machining depth D is preferably 1 mm to 5 mm irrespective of material of the substrate 2 and more preferably 1.5 mm to 3 mm. If it is set to 1 mm or deeper, then enough shading is generated to replicate the stereogram. If it is set deeper than 5 mm, then the descriptive power hardly changes, but burden on the tool becomes large. If it is set in a range from 1.5 mm to 3 mm, then burden on the tool is reduced, and favorable shading is generated.

The resolution of the machining data is for determining the size of concavo-convex. If the resolution is too low, then the three-dimensional graphic to be observed blurs, degrading the descriptive power. Setting the resolution of the machining data higher improves the observability of the three-dimensional graphic. However, if a tool having a too-small diameter corresponding to the high resolution is used, then there is a danger that the tool breaks during the machining operation, disabling the uninterrupted machining. Thus, it is preferable to set the resolution higher to the maximum extent within a range in which the tool has strength strong enough to bear the uninterrupted machining.

The shading value indicates a number of height or depth levels of the concavo-convex pattern. If the shading value is set larger, then the number of the height of depth levels increases, resulting in smooth undulation. However, setting excessively large value makes the undulation excessively smooth, making it difficult to discern the three-dimensional graphic. On the other hand, if the shading value is set too small, an angular three-dimensional graphic results, degrading the descriptive power. Appearance of the shading generated by the concavo-convex pattern, i.e., the observability of the three-dimensional graphic, varies depending on the balance between the resolution of the machining data and the shading value also, it is preferable that the shading value be determined based on the resolution of the machining data.

After creating the machining data based on the original picture data in this manner, a tool radius (R) and a machining pitch (tool feed amount) to be used in the actual machining operation are designated, and the machining data is converted into the NC data. The thus-obtained NC data is output to the machining center to execute the machining operation.

Here, the machining operation may be simulated with Mastercam. Simulating the machining operation makes it possible to see, in advance, the machining result, i.e., the observability of the three-dimensional graphic, on a computer screen without actually executing the machining operation. As described above, the observability of the three-dimensional graphic varies depending on the balance between the resolution of the machining data and the shading value. The optimal values of those however vary depending on various conditions such as the machining area size, the material of the substrate 2, complexity of the picture, strength of shading of the shaded-picture data, and the like, so it is preferable to determine the optimal values through simulation. For example, although the three-dimensional graphic can be observed when a default machining-data resolution and a default shading value preset in Mastercam are used, observability of the three-dimensional graphic is not ensured in this case. Shading can be emphasized by using optimal values to make the three-dimensional graphic easy to see.

### Second Embodiment

Next, a stereogram display member and a forming method thereof according to a second embodiment of the present invention will be described. The stereogram display member of the present embodiment is substantially the same as the stereogram display member 1 of the above-described first embodiment, but differs in that the stereogram display member of this embodiment is mainly used as a mold for forming process, whereas the stereogram display member 1 can be applied to such interior decorations as decorative objects and wall hangings. That is, the stereogram display member according to this embodiment is formed on its surface with reversed concavo-convex pattern relative to that formed on the stereogram display member 1 described above. When another stereogram display member is formed through such forming process as press molding with the stereogram display member as a mold, then the another stereogram display member replicates the same three-dimensional graphic as that the stereogram display member 1 replicates.

An original picture data used for forming the stereogram display member to be used as a mold with the reversed concavo-convex pattern is formed in the following manner. First, a picture as that shown in FIG. 2(a) is prepared, and a picture data representing the picture is created. Next, the picture data is mirror reversed and subjected to a shading process to create a shaded-picture data. In this shading process, contrary to the first embodiment, shading is added such that parts to be viewed as nearer are darker and that parts to be viewed as farther are lighter. Then, an original picture data is created based on the thus-obtained shaded-picture data in the same manner as described above. It should be noted that instead of mirror reversing the picture data, first the picture may be mirror reversed, and then a data representing the mirror-reversed picture may be created. Alternatively, the shaded-picture data or the original picture data may be mirror reversed.

By creating the original picture data in this manner, the stereogram display member of this embodiment to be used as a mold replicates a three-dimensional graphic of rabbits jumping behind a concave hemisphere. If another stereogram display member is formed using the stereogram display member as a mold, a three-dimensional graphic of rabbits jumping before a spherical moon can be observed on the another stereogram display member.

It should be noted that the forming process includes press molding, injection molding, heat forming, hollow molding, compression molding, and the like.

### Third Embodiment

Next, a stereogram display member and a forming method thereof according to a third embodiment of the present invention will be described. In this embodiment, a stereogram display member formed in the method of the first or second embodiment is used as a mold for forming another stereogram display member by forming a concavo-convex pattern (indented pattern) on a steel plate through press molding. The concavo-convex pattern formed in this manner also generate shading to replicate a stereogram, enabling a three-dimensional graphic to be observed.

For example, forming the stereogram display member 1 in the forming method of the first embodiment takes tens of hours to complete the machining, and thus mass production is difficult. However, by using a stereogram display member formed through the machining as a mold, another stereogram display members can be easily mass produced. Because press molding is well known in the art, detailed description thereof will be omitted.

### Fourth Embodiment

Next, a stereogram display member and a forming method thereof according to a fourth embodiment will be described. In this embodiment, a substrate having a surface with a concavo-convex pattern (indented pattern) is formed through a forming process with a stereogram display member formed in the forming method of the second embodiment as a mold to provide another stereogram display member. The concavo-convex pattern formed in this manner also generate shading to replicate a stereogram, enabling a three-dimensional graphic to be observed. Because the forming process using a mold is well known in the art, detailed description thereof will be omitted. It should be noted that the forming process of this embodiment may be injection molding, heat forming, hollow molding, compression molding, or the like.

### First Example

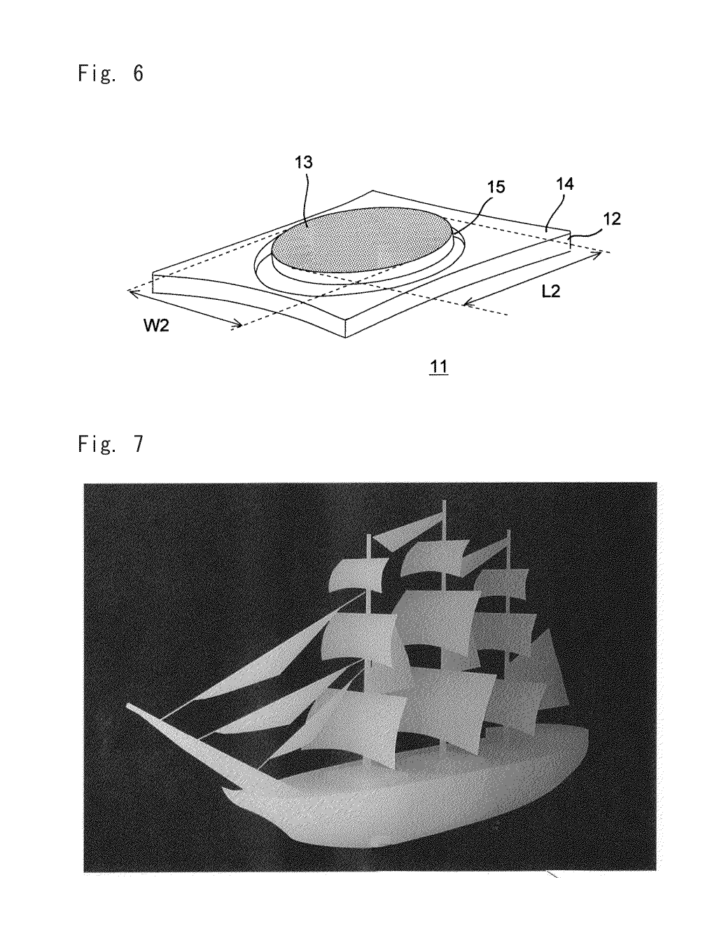

A first example of the above-described first embodiment will be described. As shown in FIG. 6, a stereogram display member 11 according to this example includes a substrate 12. A display area 13 and a frame area 14 are defined on a surface of the substrate 12, and a groove 15 as a border between the display area 13 and the frame area 14 is formed in the surface. In this example, the substrate 12 is formed of aluminum alloy. Because aluminum alloy is relatively soft, it is relatively easy to perform the uninterrupted machining without changing a tool in the middle. The substrate 12 is coated with colored Alumite, and a concavo-convex pattern is formed through machining in the display area 13 after the colored Alumite is removed.

The display area 13 is an oval in shape, and in this example the length and the width of the machining area size is defined by a length L2 and a width W2 of a rectangle in which the oval inscribes. Specifically, the length L2 is 295 mm, and the width W2 is 210 mm. The picture of “moon and rabbits” shown in FIG. 3(a) is used as a picture, and a shaded-picture data shown in FIG. 3(b) is used. The shaded-picture data is further subjected to a process for emphasizing shading. The machining depth is set to 2 mm, and the resolution of the machining data is set to 3,129 bpi, and the shading value is set to 0.000367. Machining is performed by a vertical machining center with a ball end mill with a radius of 0.5 mm, and the feed pitch is 0.1 mm.

It is confirmed that in the stereogram display member 11 formed with the above-described conditions, a stereogram is replicated by shading generated by the concavo-convex pattern formed in the display region 13 of the substrate 12, and the picture of “moon and rabbits” is clearly observed in three dimensions.

### Second Example

Next, a second example of the first embodiment will be described. This example is substantially the same as the above-described first example, but differs in that a shaded-picture data representing “sailboat” shown in FIG. 7 is used instead of the shaded-picture data of “moon and rabbits” shown in FIG. 3(b).

In this example also, it is confirmed that a stereogram is replicated by shading generated by a concavo-convex pattern formed in the display region 13 of the substrate 12 and that the picture of “sailboat” is clearly observed in three dimensions.

While the invention has been described in detail with reference to the embodiments thereof, it would be apparent to those skilled in the art that various changes and modifications may be made therein without departing from the spirit of the invention.

For example, in the above-described embodiments, the original picture data is created based on the shaded-picture data, and the machining data is created based on the original picture data. However, a scan data generated by reading a color-field stereogram printed on a paper sheet or the like may be used as the original picture data.

### EXPLANATION OF REFERENCE NUMBERS

1, 11, 21 stereogram display member

2, 12, 22 substrate

2a surface

13 display area

14 frame area

15 groove

1. A stereogram display member with a stereogram in which an image appears in three dimensions due to binocular disparity, comprising a substrate having a surface formed with a concavo-convex pattern, wherein:
the stereogram is replicated by shadings generated by the concavo-convex pattern; and
the concavo-convex pattern is formed by converting a machining data created based on an original picture data representing a color-field stereogram into an NC data and then machining the surface of the substrate based on the NC data.

2. The stereogram display member according to claim 1, wherein the concavo-convex pattern is formed such that parts corresponding to lighter parts of the color-field stereogram protrude relative to surrounding parts and that parts corresponding to darker parts of the color-field stereogram are recessed relative to surrounding parts.

3. The stereogram display member according to claim 1, wherein the maximum depth of the concavo-convex pattern is 1 mm to 5 mm.

4. The stereogram display member according to claim 1 being a mold used in a forming process.

5. A stereogram display member forming method for forming a stereogram display member with a stereogram in which an image appears in three dimensions due to binocular disparity, wherein the stereogram display member according to claim 1 is used as a mold in a forming process for forming another stereogram display member.

6. A stereogram display member forming method for forming a stereogram display member with a stereogram in which an image appears in three dimensions due to binocular disparity, comprising the steps of:
creating an original picture data representing a color-field stereogram;
creating a machining data based on the original picture data for forming a concavo-convex pattern such that parts corresponding to lighter parts of the color-field stereogram protrude relative to surrounding parts and that parts corresponding to darker parts of the color-field stereogram are recessed relative to surrounding parts;
creating an NC data based on the machining data; and
forming the concavo-convex pattern on a surface of a substrate by machining the surface of the substrate based on the NC data.
